(19) United States
(12) Patent Application Publication
(10) Pub. No.: US 2025/0341177 A1
(43) Pub. Date: Nov. 6, 2025

(54) POLYGONAL PROFILE COUPLING OF PUMPS IN A LUBRICATION ASSEMBLY

(71) Applicant: SAFRAN AERO BOOSTERS, Herstal (BE)

(72) Inventor: Quentin BORLON, Herstal (BE)

(73) Assignee: SAFRAN AERO BOOSTERS, Herstal (BE)

(21) Appl. No.: 18/868,289

(22) PCT Filed: May 15, 2023
(86) PCT No.: PCT/EP2023/063013

§ 371 Date: Nov. 22, 2024

(30) Foreign Application Priority Data
May 23, 2022 (BE) 2022/5389

(51) Int. Cl. F01D 25/20; F02C 7/32

(52) U.S. Cl. CPC F01D 25/20; F02C 7/32; F05D 2220/323; F05D 2250/11; F05D 2250/131; F05D 2260/36

(57) ABSTRACT

A lubrication assembly includes two pumps whose shafts are coupled for rotation via at least one polygonal profile coupling.

### TECHNICAL FIELD

The present invention relates to the rotational coupling between two rotary pumps of an aircraft turbomachine lubrication assembly.

### BACKGROUND

The pumps in aircraft turbomachine lubrication assemblies are generally stacked and their shafts coupled in rotation so as to obtain a rotary drive. One known way of achieving this coupling is via splines.

The splines are machined by electro-erosion or broaching. These operations are long and complex. Sometimes the splines are so small that it is necessary to use small tools that deform, making machining almost impossible.

### SUMMARY OF THE INVENTION

One object of the present invention is to obtain a lubrication assembly that is easier to manufacture. To this end, the invention proposes a lubrication assembly for an aircraft turbomachine comprising:
a first pump comprising a first shaft;
a second pump comprising a second shaft;
   characterised in that the first shaft and the second shaft are mechanically coupled via at least one polygonal profile coupling.

The polygonal profile coupling can be machined by milling (female) or turning (male). It is therefore easier to produce than the spline coupling.

The polygonal profile couplings are known to the person skilled in the art, in particular through the standards DIN 32711 parts 1 and 2.

According to one embodiment, the first shaft and the second shaft are coupled for rotation via said at least one polygonal profile coupling.

According to an embodiment, the second shaft is mechanically coupled to the first shaft by a coupling element, and the coupling element comprises a first end forming a male part of a first polygonal profile coupling and the first shaft comprises a first end forming a female part of said first polygonal profile coupling.

According to an embodiment, said male and female parts are separate from each other.

The fact that the male and female parts are separate allows the gap between them to take up the misalignment of the shafts.

According to a preferred embodiment, the invention relates to a lubrication assembly for an aircraft turbomachine comprising:
a first pump comprising a first shaft;
a second pump comprising a second shaft mechanically coupled to the first shaft by a coupling element;
   characterised in that the coupling element comprises a first end forming a male part of a first polygonal profile coupling and the first shaft comprises a first end forming a female part of said first polygonal profile coupling, said male and female parts being separate from each other.

According to an embodiment, the profile of the first end of the coupling element and the profile of the first end of the first shaft satisfy the following equalities:

$$x ( α ) = [ {R}_{m} - e \cdot cos ( n \cdot α ) ] \cdot cos ( n \cdot α ) - n \cdot e \cdot sin ( n \cdot α ) \cdot sin ( α ) \\ y ( α ) = [ {R}_{m} - e \cdot cos ( n \cdot α ) ] \cdot sin ( n \cdot α ) + n \cdot e \cdot sin ( n \cdot α ) \cdot cos ( α )$$

where α is a variable, x and y are Cartesian coordinates, Rₘ is a first parameter, e is a second parameter, and n is a third integer parameter greater than or equal to 3.

Rₘ and e are smaller for the first end of the coupling element than for the first end of the first shaft so that the female part is wider than the male part. n has the same value for the first end of the coupling element as for the first end of the first shaft.

According to an embodiment, the male and female parts of the first polygonal profile coupling have three sides. The male and female parts are essentially triangles with rounded corners. Therefore, n=3 in the equations.

According to an embodiment, the male part and the female part of the first polygonal profile coupling are at least 10 μm apart.

According to an embodiment, the coupling element is in one piece with the second shaft.

According to an embodiment, the second shaft comprises a first end joined to a second end of the coupling element.

According to an embodiment, the coupling element is a different piece from the second shaft.

According to an embodiment, the coupling element comprises a second end forming a male part of a second polygonal profile coupling and the second shaft comprises a first end forming a female part of said second polygonal profile coupling, said male and female parts being separate from each other.

According to an embodiment, the profile of the second end of the coupling element and the profile of the first end of the second shaft satisfy the following equalities:

$$x ( α ) = [ {R}_{m} - e \cdot cos ( n \cdot α ) ] \cdot cos ( n \cdot α ) - n \cdot e \cdot sin ( n \cdot α ) \cdot sin ( α ) \\ y ( α ) = [ {R}_{m} - e \cdot cos ( n \cdot α ) ] \cdot sin ( n \cdot α ) + n \cdot e \cdot sin ( n \cdot α ) \cdot cos ( α )$$

where α is a variable, x and y are Cartesian coordinates, Rₘ is a first parameter, e is a second parameter, and n is a third integer parameter greater than or equal to 3.

Rₘ and e are smaller for the second end of the coupling element than for the first end of the second shaft. n has the same value for the second end of the coupling element as for the first end of the second shaft.

According to an embodiment, the male and female parts of the second polygonal profile coupling have three sides.

According to an embodiment, the male and female parts of the second polygonal profile coupling are at least 10 μm apart.

According to an embodiment, the first and second pumps are vane pumps.

According to an embodiment, the first and second pumps are desmodromic vane pumps or gerotor pumps.

According to an embodiment, the lubrication assembly further comprises a third pump comprising a third shaft mechanically coupled to the second shaft by a further coupling element, wherein the further coupling element comprises a further first end forming a male part of a further polygonal profile coupling and the second shaft comprises a second end forming a female part of said further polygonal profile coupling, the male and female parts of said further polygonal profile coupling being separate from each other.

The invention also provides an aircraft comprising a lubrication assembly as described herein.

### BRIEF DESCRIPTION OF THE FIGURES

Further characteristics and advantages of the invention will become apparent from the following detailed description, for the understanding of which reference is made to the appended figures, among which:

FIG. 1 is a diagram of a lubrication assembly compatible with the invention,

FIG. 2 is a diagram of another lubrication assembly compatible with the invention,

FIG. 3 is a cross-sectional view of a polygonal profile coupling compatible with the invention,

FIG. 4 is a cross-sectional view of a polygonal profile compatible with the invention, and

FIG. 5 is a cross-sectional view of another polygonal profile compatible with the invention.

### EMBODIMENTS OF THE INVENTION

The present invention is described with particular embodiments and references to figures but the invention is not limited thereby. The drawings or figures described are only schematic and are not limiting. In addition, the functions described may be carried out by structures other than those described in this document.

In the context of this present document, the terms “first” and “second” are used only to differentiate the various elements and do not imply an order between these elements.

In the figures, the identical or similar elements may have the same references.

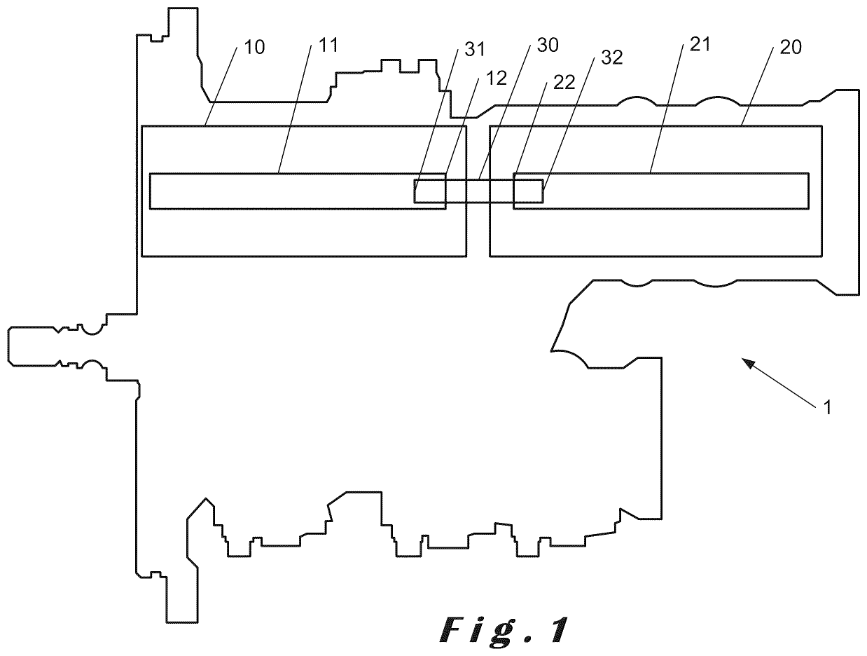

FIG. 1 illustrates a lubrication assembly 1 according to one embodiment of the invention. It comprises a first pump 10 comprising a first shaft 11 and a second pump 20 comprising a second shaft 21. The shafts 11, 21 are mechanically coupled so that one can rotate the other. This coupling is achieved via a coupling element 30 which comprises a first end 31 and a second end 32, opposite the first end 31.

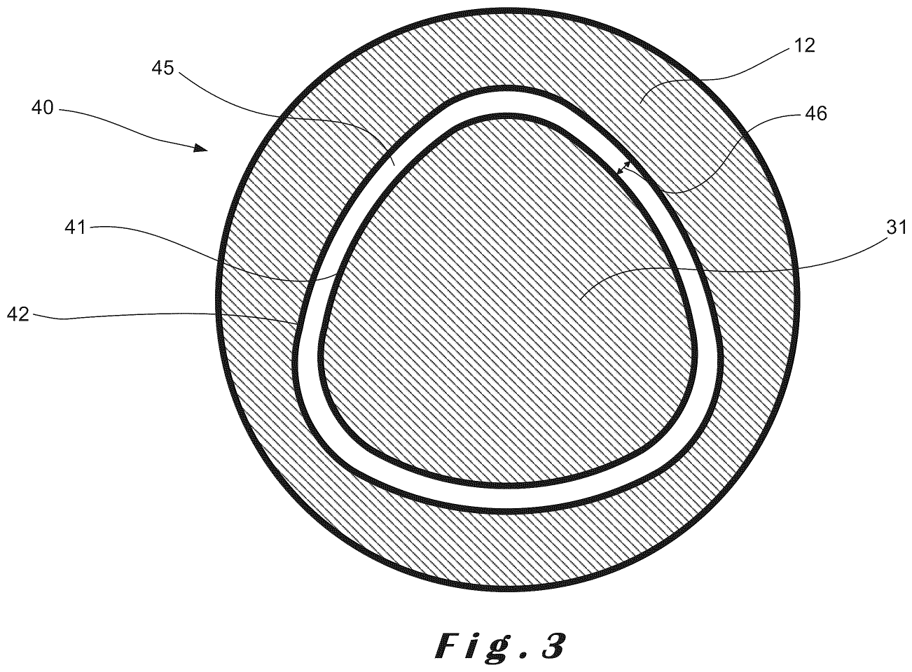

The first shaft 11 comprises a first end 12. The second shaft 21 comprises a first end 22 and a second end 23. The first end 31 of the coupling element 30 is engaged in the first end 12 of the first shaft 11. The first end 31 of the coupling element 30 thus forms a male part 41 of a first polygonal profile coupling 40 (which will be described with reference to FIG. 3), the first end 12 of the first shaft 11 forming a female part 42 of said first polygonal profile coupling 40.

According to an embodiment shown in FIG. 1, the second end 32 of the coupling element 30 is engaged in the first end 22 of the second shaft 21. The second end 32 of the coupling element 30 thus forms a male part 41 of a second polygonal profile coupling 40 (which will be described with reference to FIG. 3), the first end 22 of the second shaft 21 forming a female part 42 of said second polygonal profile coupling 40.

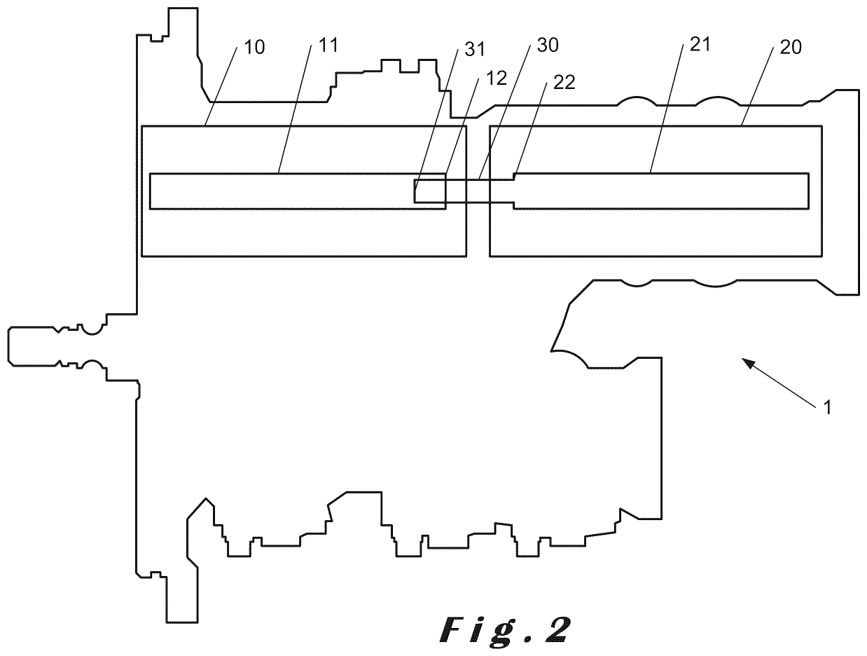

In the embodiment shown in FIG. 2, the second end 32 of the coupling element 30 is joined to the first end 22 of the second shaft 21 so that the coupling element 30 and the second shaft 21 form a single piece.

The lubrication assembly 1 may comprise a third pump, a fourth one and so on. The pumps are stacked and their shafts are coupled for rotation via a polygonal profile coupling 40. For example, a third shaft of a third pump can be mechanically coupled to the second end 23 of the second shaft 22 by another coupling element, which comprises another first end. The other first end forms a male part of a further polygonal profile coupling and the second end 23 of the second shaft 22 forms a female part of said further polygonal profile coupling.

The pumps 10, 20 are preferably vane pumps, for example desmodromic, or gerotor pumps.

FIG. 3 is an example of a coupling using polygonal profiles 40 between a male part 41 and a female part 42 which are separate from each other. The coupling 40 shown in FIG. 3 may be a first (the references 12 and 31 correspond thereto), second, and/or other polygonal profile coupling of the present disclosure. The fact that the male part 41 and the female part 42 are separate means that they are not attached to each other. In addition, although they may be in contact when driven, at rest there is a space 45 around the male part 41, which separates it from the female part 42. The distance 46 between the male part 41 and the female part 42 can be at least 10 μm, preferably at least 100 μm. This distance 46 is measured in a cross-sectional plane, for example when the male 41 and female 42 parts are aligned on the same axis.

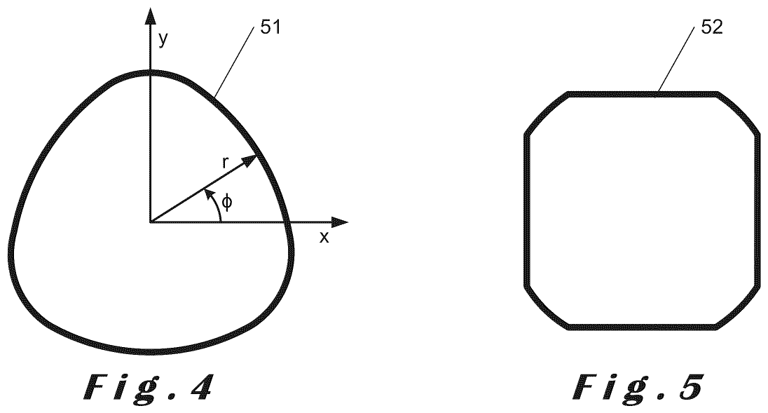

FIG. 4 shows a triangular polygonal profile, with a Cartesian coordinate system (x, y) and a polar coordinate system (r, ϕ). In general, a polygonal profile is defined by the following equations in Cartesian coordinates:

$$x ( α ) = [ {R}_{m} - e \cdot cos ( n \cdot α ) ] \cdot cos ( n \cdot α ) - n \cdot e \cdot sin ( n \cdot α ) \cdot sin ( α ) \\ y ( α ) = [ {R}_{m} - e \cdot cos ( n \cdot α ) ] \cdot sin ( n \cdot α ) + n \cdot e \cdot sin ( n \cdot α ) \cdot cos ( α )$$

In polar coordinates, this translates into

$$ρ ( α ) = \sqrt{{[ {R}_{m} - e \cdot cos ( n \cdot α ) ]}^{2} + {[ n \cdot e \cdot sin ( n \cdot α ) ]}^{2}} \\ Φ ( α ) = α + arctan [ \frac{n \cdot e \cdot sin ( n \cdot α )}{{R}_{m} - e \cdot cos ( n \cdot α )} ]$$

α is a variable, Rₘ is a first parameter, e is a second parameter, and n is a third parameter. n is an integer greater than or equal to 3. 3 is required for FIG. 4 (triangular polygonal profile), and 4 for FIG. 5 (quadrilateral polygonal profile). α varies so as to follow the curve of the polygonal profile. n is identical for the male part 41 and the female part 42. Rₘ and e are smaller for the male part 41 than for the female part 42. In other words, the female part 42 has a wider profile than the male part 41.

In other words, the invention relates to a lubrication assembly 1 comprising two pumps 10, 20 whose shafts 11, 21 are coupled in rotation via at least one polygonal profile coupling 40.

The present invention has been described above in connection with specific embodiments, which are illustrative and should not be considered limiting. In a general manner, the present invention is not limited to the examples illustrated and/or described above. The use of the verbs “include”, “comprise”, or any other variant, as well as their conjugations, can in no way exclude the presence of elements other than those mentioned. The use of the indefinite article “a”, “an”, or the definite article “the”, to introduce an element does not exclude the presence of a plurality of these elements. The reference numbers in the claims do not limit their scope.

1. A lubrication assembly for an aircraft turbomachine, comprising:
a first pump comprising a first shaft; and
a second pump comprising a second shaft,
wherein the first shaft and the second shaft are mechanically coupled via at least one polygonal profile coupling.

2. The lubrication assembly according to claim 1, wherein the first shaft and the second shaft are coupled in rotation via said at least one polygonal profile coupling.

3. The lubrication assembly according to claim 1, wherein the second shaft is mechanically coupled to the first shaft by a coupling element, and wherein the coupling element comprises a first end forming a male part of a first polygonal profile coupling and the first shaft comprises a first end forming a female part of said first polygonal profile coupling.

4. The lubrication assembly according to claim 3, wherein said male part and said female part are separate from each other.

5. The lubrication assembly according to claim 3, wherein a profile of the first end of the coupling element and a profile of the first end of the first shaft satisfy the following equations:
$$x ( α ) = [ {R}_{m} - e \cdot cos ( n \cdot α ) ] \cdot cos ( n \cdot α ) - n \cdot e \cdot sin ( n \cdot α ) \cdot sin ( α ) \\ y ( α ) = [ {R}_{m} - e \cdot cos ( n \cdot α ) ] \cdot sin ( n \cdot α ) + n \cdot e \cdot sin ( n \cdot α ) \cdot cos ( α )$$
where α is a variable, x and y are Cartesian coordinates, Rₘ is a first parameter, e is a second parameter, and n is a third integer parameter greater than or equal to 3.

6. The lubrication assembly according to claim 3, wherein the male part and the female part of the first polygonal profile coupling have three sides.

7. The lubrication assembly according to claim 3, wherein the male part and the female part of the first polygonal profile coupling are at least 10 μm apart.

8. The lubrication assembly according to claim 3, wherein the coupling element is in one piece with the second shaft.

9. The lubrication assembly according to claim 8, wherein the second shaft comprises a first end joined to a second end of the coupling element.

10. The lubrication assembly according to claim 3, wherein the coupling element is a different piece from the second shaft.

11. The lubrication assembly according to claim 10, wherein the coupling element comprises a second end forming a male part of a second polygonal profile coupling and the second shaft comprises a first end forming a female part of said second polygonal profile coupling, said male and female parts being separate from each other.

12. The lubrication assembly according to claim 11, wherein the profile of the second end of the coupling element and the profile of the first end of the second shaft satisfy the following equalities:
$$x ( α ) = [ {R}_{m} - e \cdot cos ( n \cdot α ) ] \cdot cos ( n \cdot α ) - n \cdot e \cdot sin ( n \cdot α ) \cdot sin ( α ) \\ y ( α ) = [ {R}_{m} - e \cdot cos ( n \cdot α ) ] \cdot sin ( n \cdot α ) + n \cdot e \cdot sin ( n \cdot α ) \cdot cos ( α )$$
where α is a variable, x and y are Cartesian coordinates, Rₘ is a first parameter, e is a second parameter, and n is a third integer parameter greater than or equal to 3.

13. The lubrication assembly according to claim 1, wherein the first and second pumps are vane pumps.

14. The lubrication assembly according to claim 1, further comprising a third pump comprising a third shaft mechanically coupled to the second shaft by a further coupling element, wherein the further coupling element comprises a further first end forming a male part of a further polygonal profile coupling and the second shaft comprises a second end forming a female part of said further polygonal profile coupling, the male and female parts of said further polygonal profile coupling being separate from each other.

15. An aircraft comprising the lubrication assembly according to claim 1.

16. The lubrication assembly according to claim 13, wherein the first and second pumps are desmodromic vane pumps or gerotor pumps.
